(19) United States
(12) Patent Application Publication
(10) Pub. No.: US 2010/0240450 A1
(43) Pub. Date: Sep. 23, 2010

(54) Ultimate gamer challenge maker

(75) Inventors: Miguel Anthony Vargas, Miami, FL (US); Robert Morales, Miami, FL (US); Germaen Herrera, Miami, FL (US); Felix Javier Mostelac Trujillo, Miami, FL (US)

Correspondence Address: Miguel Anthony Vargas, 13131 SW 56 Terrace, Miami, FL, 33183, US

(73) Assignee: Miguel Anthony Vargas, Miami, FL (US)

(21) Appl. No.: 12/660,844

(22) Filed: Mar. 5, 2010

(51) Int. Cl. A63F 9/24; A63F 13/00

(52) U.S. Cl. 463/29; 463/25; 463/31; 463/42

(57) ABSTRACT

That The Ultimate Gamer Challenge Maker is a concept that intertwines various aspects of sports, video games, legal wagering and broadcast media all merged within a virtual environment. This process allows video game players to become actual professionals in the field of video game playing and even earn a virtual living through the applications innovative gamer gratification refund program. By giving video game players the opportunity to challenge each other directly in video games, the application has legally innovated a process in which video game players can finally have a definitive answer to the outcome of a video game match based on a video game players skill without having the tournament limitation. This unique idea will bring all types of video game players throughout the world together in a virtual environment with one common purpose: To determine who is the greatest video game player in the world.

### FIELD OF THE INVENTION

The present invention relates to video game players and, more particularly, to facilitating a virtual environment in order to allow video game players to become a virtual professional video game player, live in a virtual world and compete against one another in the field of playing video games.

### BACKGROUND OF THE INVENTION

Ever since the invention of the portable video game machine, video game players have always questioned who is the greatest video game player in the world. The basic problem with that question is that there is no official way of judging video game players based on their skill.

The only solution available to video game players is to enter into what is referred to as a video game tournament.

Although various entities have offered tournaments to video game players, these tournaments are subject to limitations due to either the theory of the tournaments or the distance required to travel in order to participate is said video game tournament. Even said video game tournaments that are Internet based are flawed because of the limitations concerning the types of video games that can be played and the simple ‘winner take all’ theory behind them. Video game players seek more than just winning a video game, they want to compete and receive the gratification of being victorious without having to enter into these long, drawn out video game tournaments that offer little to both the imagination and the judgement of a video game players actual skill. Most solutions only allow video game players to play against one another. There is no solution to determine an actual video game players respective skill without having to enter into a video game tournament. Furthermore, once a video game player loses in one of these video game tournaments, the player can no longer continue to participate in said video game tournament would be advantageous to provide a vast virtual environment that can be reached from any communicable source via the Internet wherein a video game player can challenge, compete and immerse itself via a virtual avatar to interact and play with other virtual video game players within this virtual environment.

It would also be advantageous to provide a virtual environment wherein a video game player not only can challenge and compete against one another for virtual points but will also be able to become an actual professional video game player. The professional video game player will have the ability to build a virtual house, purchase limitless virtual accessories, use virtual points in order to challenge opponents for bragging rights and even star on a virtual television network within said virtual environment wherein a video game player's actual game can be broadcast for all to see.

It would further be advantageous to provide a video game player an actual chance to earn a real-world cash reward in the form of debit gift cards by winning video game matches against other players. This gamer gratification refund program will not only allow video game players to win cash prizes but most importantly it will give them a true sense of gratification that their skill in playing video games is finally rewarded. No other theory or solution comes even remotely close to the advantages based within this invention.

### SUMMARY OF THE INVENTION

In accordance with the present invention, there is provided that The Ultimate Gamer Challenge Maker is a concept that intertwines various aspects of sports, video games, legal wagering and broadcast media all merged within a virtual environment. This process allows video game players to become actual professionals in the field of video game playing and even earn a virtual living through the applications innovative gamer gratification refund program. By giving video game players the opportunity to challenge each other directly in video games, The Ultimate Gamer Challenge Maker has legally innovated a process in which video game players can finally have a definitive answer to the outcome of a video game match based on a video game players skill without having the tournament limitation. From creating your own virtual avatar to seeing the garners virtual self on virtual broadcast shows and highlights, The Ultimate Gamer Challenge Maker is a unique idea that will bring all types of video game players throughout the world together with one common purpose: To determine who is the greatest video game player in the world.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top plan view of the initial entry into the ultimate gamer challenge maker application after the video game players enters into our system, the gamer is directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment;

FIG. 2 is a top sectional view of a challenge screen wherein the gamer can explore how many players are available to compete against after the gamer selects another v.i.p. member from the challenge screen menu; the gamer can then set the video game that is to be played and set the amount of challenge points that the gamer wants to wager for the video game contest using the challenge point system;

FIG. 3 is a left plan view of a sub-menu within the challenge screen that will verify v.i.p. member 1 challenge, the video game to be played and the amount of challenge points that can be won after the video game competition is completed once all of these criteria are set, both or all of equal numbers of video game players can therefore enter the video game platform and begin competing against each other in the video game environment;

FIG. 4 is a right plan view of a sub-menu within the challenge screen that will verify v.i.p. member 2 challenge, the video game to be played and the amount of challenge points that can be won after the video game competition is completed once all of these criteria are set, both or all of equal numbers of video game players can therefore enter the video game platform and begin competing against each other in the video game environment;

FIG. 5 is a plan view of a video game competition that is being played in said agreed to competition;

FIG. 6 is a bottom plan view of the ultimate gamer challenge maker application verification application of the video game that was played and the outcome of said contest the ultimate gamer challenge maker application will verify that the video game competition was played according to the rules of said video game and then issue the winning challenge points to the winning virtual interactive professional (v.i.p.) the winning virtual interactive professional will also receive winner experience points. these winner experience points will allow the v.i.p. to access one of four levels of gaming experience after achieving a pre-determined winner experience points number in order to level up these four levels will be labeled as rookie, professional, all-star and master; and

FIG. 7 is a bottom section view of an application reverting to the initial entry into the ultimate gamer challenge maker application after the video game players finish playing the said competition and finish circumventing the various sub-menu's, the gamer is once again directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment.

For purposes of clarity and brevity, like elements and components will bear the same designations and numbering throughout the Figures.

### DESCRIPTION OF THE PREFERRED EMBODIMENT

The Ultimate Gamer Challenge Maker is an application that allows video game players to challenge one another in a virtual environment. This virtual environment will contain a virtual world that will allow video game players to become actual professional video game players and challenge each other within the environment. The application and concept will be programmed to lawfully allow garners over the age of 18 years old to use a system of ‘Challenge Points’ to take on opponents and finally put a ‘price’ on how good your individual skill is. ‘Challenge Points’ will be made both available for purchase either online or via commercial stores and they will also be available by earning them through playing one-on-one (or equal numbers of players-game dependent) competition against a rival opponent. The more opponents that a gamer defeats the higher the ranking the gamer will receive within the applications vast virtual environment. This application will replicate a very light, family friendly way of friendly wagering on video games while also allowing the member to live in a competitive virtual environment enabled by the creation of the gamers VIP or Virtual Interactive Professional. The Ultimate Gamer Challenge Maker is not a game of chance because it allows two players to play a video game against one another via the Internet or any other method of playing video games and they will have full control of any given video game on any given platform or system. Players will be subject to the official rules of any given video game and will have an equal playing field so The Ultimate Gamer Challenge Maker application therefore abides by the strict United States Anti-Gambling Act of 2006 amended within the United States SAFE Port Act of 2006. The Ultimate Gamer Challenge Maker will use a very intricate virtual economic model. This model is based on a simple point system entitled ‘Challenge Points’. The ‘Challenge Points’ system is a virtual credit that can be used to challenge opponents to a video game competition 18 on any platform or video game system via the garners preferential online service or any method of single equal competitive video game environment in combination with the use of The Ultimate Gamer Challenge Maker application. The Ultimate Gamer Challenge Maker will not only act as a service that will allow members to use a virtual credit to challenge opponents to online video games but will also allow members to live in a virtual world as a virtual video game professional competitor or ‘VIP’ (Virtual Interactive Professional). The members ‘VIP’ will have the ability to buy virtual property, sign virtual contracts with virtual agents, buy virtual clothing, apparel, jewelry, shoes, housing, cars etc . . . etc . . . The Ultimate Gamer Challenge Maker will have no limits in virtual gaming. All of the real-life aspects of any professional ‘athlete’ will be available to The Ultimate Gamer Challenge Maker-Virtual Interactive Professional-video game players. The Ultimate Gamer Challenge Maker is not just about simulating the life of a professional ‘athlete’ it is about challenging the real life skill of the actual video game player on an equal setting no matter what type of video game is being played. The Ultimate Gamer Challenge Maker will allow video game players to challenge each other on an equal basis and compete for ‘Challenge Points’. ‘Challenge Points’ are not free. We will offer video game players direct access to ‘Challenge Points’ via our website, reaching an agreement with video game and/or 3rd party providers and/or placing our gift card system in commercial stores so that video game players do not have to use neither a credit card or other form of electronic payment in order to enjoy the action. These ‘Challenge Points’ will then be added to the user's account where the user can challenge fellow application members to any similar video game on any console or PC of their choice via the Internet or any method of video game playing. The users would set the amount of ‘Challenge Points’ that will be pre-determined prior to playing said video game and then compete for that prize in the video game, accept the amount of ‘Challenge Points’ for the video game; play the video game and the winner would therefore receive the losing opponents ‘Challenge Points’. The Ultimate Gamer Challenge Maker members will also have the added benefit of earning extra ‘Challenge Points’ by gaining ‘Winner Experience Points’ which will allow the gamer to increase levels of play and weed out the lesser competition. Simply put, the more you win within the application, the higher the level of competition you play and the higher the amount of ‘Challenge Points’ which can used to compete against another gamer. What will set The Ultimate Gamer Challenge Maker apart from the competition will be the added fact that the video game player will actually be able to win cash prizes by playing one another in video game competition 18. These cash prizes will be able to be redeemed via The Ultimate Gamer Challenge Maker website. At any given time, the video game player will be given the option to make a one-time exchange with The Ultimate Gamer Challenge Maker website by exchanging winning ‘Challenge Points’ for refundable cash gift debit cards which will be mailed to the gamer after a nominal transaction fee is applied to the ‘Challenge Points’. This exchange is known as ‘Gamer Gratification Refund Program’ and will be optioned to the video game member within a menu and will be available for as long as the member continues to play, compete and win in video games. The video game member will also have the option to opt to keep their ‘Challenge Points’ and use them to purchase virtual items at any time in our website virtual store.

The ‘Ultimate Gamer Bowl’

Once a year, The Ultimate Gamer Challenge Maker will host a tournament for the best video game players on various platforms that will coincide with each other in order to determine ‘who's really the greatest video game player in the world?’ in what will be called ‘The Ultimate Gamer Bowl.’ The tournament winner will not only receive a cash prize for winning the tournament but will also receive an equivalent ‘Challenge Points’ prize as well. The winner of this tournament will also be The Ultimate Gamer Challenge Maker applications ‘Ultimate Master’ and will retain that title until the following year's tournament.

There will be four levels of achievement within The Ultimate Gamer Challenge Maker. These levels could be attained by winning and receiving ‘Winner Experience Points’. These ‘Winner Experience Points’ will accumulate until a predetermined number is reached and the video game player can therefore raise to the next level of competition and compete against more wealthy ‘Challenge Point’ members. These four levels will be entitled: ROOKIE, PRO, ALLSTAR, MASTER. As members accumulate ‘Winner Experience Points’ and reach certain stated milestones within the application; Players will have the ability to earn further cash prizes in the form of The Ultimate Gamer Challenge Maker gift cards in the form of one-time use gift debit cards. In order to receive these cash prizes, members will have the option to exchange their ‘Winner Experience Points’ for level up gift cards. Once those ‘Winner Experience Points’ are cashed in, the players lose those ‘Winner Experience Points’ within the application and they will be subtracted from the players overall ‘Winner Experience Points’ total. These cash prizes will be available via The Ultimate Gamer Challenge Maker website. Allowing the video game players to earn cash prizes as a reward will further drive traffic towards both the application and the website. It will also give the video game player a certain amount of real ‘accomplishment’ for being proficient in using his/her individual gaming skills.

‘The Ultimate Gamer Challenge Maker’ will also innovate a new way to use your VIP in our virtual gaming world. You Virtual Interactive Professional will be a single based 3D avatar that will resemble a facade that can be created however the member would like it to resemble. Using our applications ULTIMATE GAMER VIP CREATOR, the member will be able to customize his very own virtual character with a vast array of styles and will be given the opportunity to ‘room’ with other online VIP avatars while acquiring the required number of ‘Challenge Points’ in order to purchase the members very own virtual habitat or ‘place’. From the dorm to the mansion, subscribed members' VIP avatars will be allowed to evolve with its experiences, purchases, wins and interact within The Ultimate Gamer Challenge Maker vast virtual world. VIP's will interact with other members of their prescribed level by literally being put in a situation where the member is placed at an equal level to those video game players that play at a predetermined skill level or ‘living on their block’. Simply put, this VIP system will work as the most sophisticated ‘gaming oriented’ social networking in the modern world. In The Ultimate Gamer Challenge Maker application you're not only just a video game player, you're a professional. Members will be able to ‘live the dream’ of a virtual professional video game player, live in a virtual world and be able to reap all of its vast rewards, both virtually and realistically. Your VIP will be able to access all of the amenities within our virtual environment which includes but it is not limited to most of the real life aspects of the gaming culture including but not limited to The Ultimate Gamer Challenge Maker Interactive Virtual Gaming Network.

Interactive Virtual Gaming Network

The Ultimate Gamer Challenge Maker Interactive Virtual Gaming Network will literally be a ‘virtual’ real live television network with all of the facets of any media or television broadcasting network. Highlights, Live Game casts, Game shows, News and every single current and future ideas in the multi-media broadcast television industry will be applied to this virtual broadcast company. We will broadcast including but not limited to live video game contests, tournaments, newscasts and gamer spotlights. The Ultimate Gamer Challenge Maker Interactive Virtual Gaming Network will literally push the boundaries of how video game play is viewed, followed and perceived throughout the world. The Interactive Virtual Gaming Network idea is based on the basic structure of modern day television. We will take feeds off of computer servers (or any available broadcast sources) that any video game player is playing and broadcast them in all types of broadcasting formats via all forms of available media.

The Ultimate Virtual Agent

The Ultimate Virtual Agent—From herein any and all terms or associations concerning the word, term or reference to the word, words or phrase of the word, term or phrase ‘Virtual Agent’ shall herein be the exclusive right of ‘The Ultimate Gamer Challenge Maker’ and/or its parent company. The term ‘Virtual Agent’ shall herein be defined as a real life person that it acting on the behalf of a real life individual whom is representing a said real world person's ‘virtual avatar’. It is furthermore defined as any and all ‘virtual avatars’ that are contractually hired by ‘virtual gaming avatars’ for representation within any and all virtual worlds shall be subject to approval, refusal and/or termination of services by ‘The Ultimate Gamer Challenge Maker’ and/or parent company. All virtual or real world agents representing any member of this service shall be subject to acceptance, refusal or termination of licensing by ‘The Ultimate Gamer Challenge Maker’ and/or its parent company. ‘The Ultimate Gamer Challenge Maker’ will also include a virtual agent licensing service. This service will be available (at cost) to members whom want to ‘manage’ other members in their virtual careers. The ‘Ultimate Virtual Agents’ will have the access to a pool of ‘The Ultimate Gamer Challenge Maker’ Virtual Interactive Professionals' (VIP) and be able to negotiate deals as representatives of these virtual clients. ‘The Ultimate Gamer Challenge Matchmaker’ will be in strict control of all ‘virtual avatars’ within our system and structure. We reserve the right to accept, refuse or terminate service to any and all members that do not abide by any and all standards, regulations, rules, code of conduct as well as but not limited to all policies set by ‘The Ultimate Gamer Challenge Maker’ and/or its parent company. We reserve the right to change all policies at our convenience. Players are strictly forbidden from neither exchanging ‘Challenge Points’ amongst one another and are not allowed to use ‘Challenge Points’ as a means to ‘wager’ or ‘bet’ upon another member's game. All challenges are to be made against one other player or equal number of players depending on the basis of the video game. ‘The Ultimate Gamer Challenge Maker’ reserves the right to set all rules for this service and will enforce those rules as it deems fit. The Terms: Challenge Points (CP), Winner Experience Points (WES), Virtual Interactive Professional (VIP), Interactive Virtual Gaming Network (IVGN), Ultimate Virtual Agents (VAG) and any and ALL ideas whether expressed directly or indirectly referring to the substance of this material shall herein be considered as part of a whole of this patent. ‘The Ultimate Gamer Challenge Maker’ reserves the right to all of the concepts included but not limited to the ideas written within this document.

### DRAWINGS-FIGURES

In the flowchart drawings, related figures are represented by alphabetic suffixes.

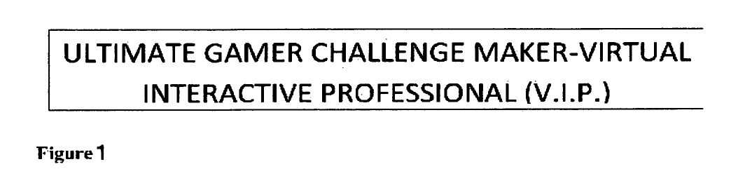

FIG. 1) represents the initial entry into The Ultimate Gamer Challenge Maker application Virtual Interactive Professional Main Menu 10. After the video game players enters into our system, the gamer is directed into the video game player's Virtual Interactive Professional (V.I.P.) page where the video game players has various options such as but not limited to buying virtual accessories, housing, exchanging winning challenge points for gift cards, challenging other members in our service or navigating The Ultimate Gamer Challenge Maker vast virtual environment.

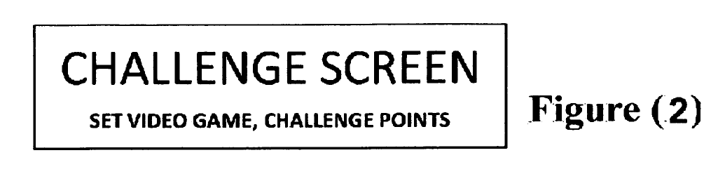

FIG. 2) represents the Video Game Player 1 Challenge Screen Sub-Menu 14 wherein the gamer can explore how many players are available to compete against. After the gamer selects another V.I.P. member from the Challenge Screen menu 12; the gamer can then set the video game that is to be played and set the amount of Challenge Points that the gamer wants to wager for the video game contest using the CHALLENGE POINT system.

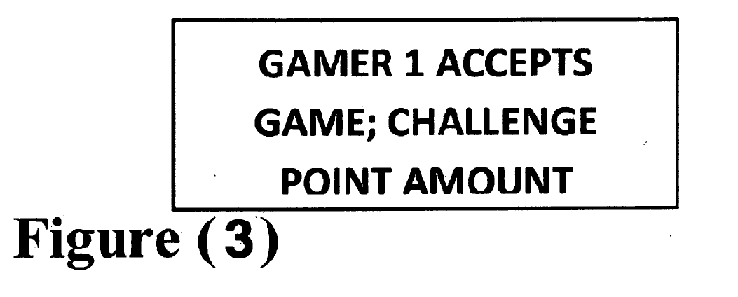

FIG. 3) represent the Video Game Player 2 Challenge Screen Sub-Menu 16 that will verify each V.I.P. member's challenge, the video game to be played and the amount of Challenge Points that can be won after the video game competition 18 is completed. Once all of these criteria are set, both or all of equal numbers of video game players can therefore enter the video game platform and begin competing against each other in the video game environment.

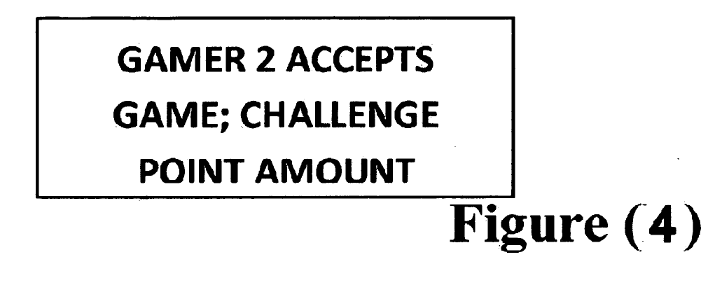

FIG. 4) represent The Ultimate Gamer Challenge Maker Verification Menu 20 that will verify each V.I.P. member's challenge, the video game to be played and the amount of Challenge Points that can be won after the video game competition 18 is completed. Once all of these criteria are set, both or all of equal numbers of video game players can therefore enter the video game platform and begin competing against each other in the video game environment.

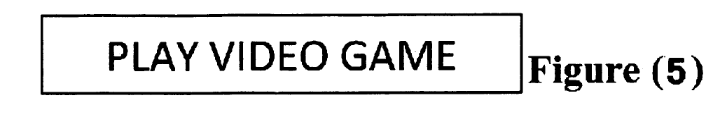

FIG. 5) represents the video game that is being played in said agreed to competition.

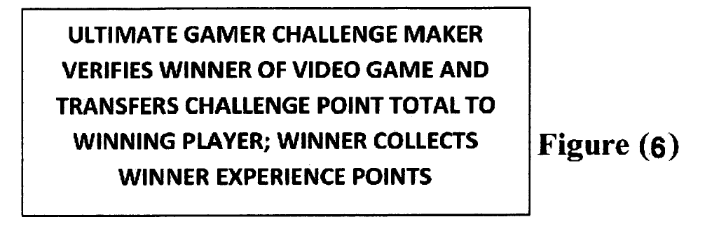

FIG. 6) represents The Ultimate Gamer Challenge Maker application verification within the of the video game that was played and the outcome of said contest. The Ultimate Gamer Challenge Maker application will verify that the video game competition 18 was played according to the rules of said video game and then issue the winning Challenge Points to the winning Virtual Interactive Professional (V.I.P). The winning Virtual interactive Professional will also receive Winner Experience Points. These Winner Experience points will allow the V.I.P. to access one of four levels of gaming experience after achieving a pre-determined Winner Experience Points number in order to level up. These four levels will be labeled as Rookie, Professional, All-Star and Master.

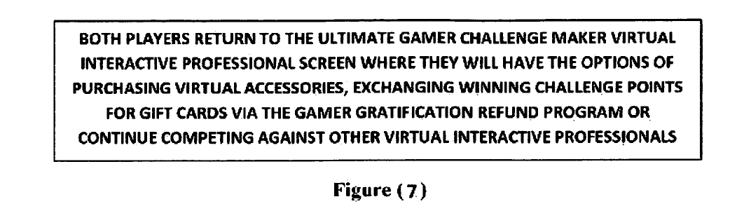

FIG. 7) represents the application reverting to the initial entry into the Virtual Interactive Professional Main Menu 10. After the video game players finish playing the said competition and finish circumventing the various sub-menu's, the gamer is once again directed into the video game player's Virtual Interactive Professional (V.I.P.) page where the video game players has various options such as but not limited to buying virtual accessories, housing, exchanging winning challenge points for gift cards, challenging other members in our service or navigating The Ultimate Gamer Challenge Maker vast virtual environment.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An ultimate gamer challenge maker for facilitating video game players to live in a virtual world, become virtual professional video game players and compete against one another, comprising:
means for the initial entry into the ultimate gamer challenge maker application. after the video game players enters into our system, the gamer is directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment;
means for wherein the gamer can explore how many players are available to compete against. after the gamer selects another v.i.p. member from the challenge screen menu; the gamer can then set the video game that is to be played and set the amount of challenge points that the gamer wants to wager for the video game contest using the challenge point system, sealably connected to said means for the initial entry into the ultimate gamer challenge maker application after the video game players enters into our system, the gamer is directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment;
means for a sub-menu within the challenge screen that will verify v.i.p. member 1 challenge, the video game to be played and the amount of challenge points that can be won after the video game competition is completed once all of these criteria are set, both or all of equal numbers of video game players can therefore enter the video game platform and begin competing against each other in the video game environment, rigidly connected to said means for wherein the gamer can explore how many players are available to compete against. after the gamer selects another v.i.p. member from the challenge screen menu; the gamer can then set the video game that is to be played and set the amount of challenge points that the gamer wants to wager for the video game contest using the challenge point system;
means for a sub-menu within the challenge screen that will verify v.i.p. member 2 challenge, the video game to be played and the amount of challenge points that can be won after the video game competition is completed once all of these criteria are set, both or all of equal numbers of video game players can therefore enter the video game platform and begin competing against each other in the video game environment, rigidly connected to said means for wherein the gamer can explore how many players are available to compete against. after the gamer selects another v.i.p. member from the challenge screen menu; the gamer can then set the video game that is to be played and set the amount of challenge points that the gamer wants to wager for the video game contest using the challenge point system;
means for the video game competition that is being played in said agreed to competition, rigidly connected to said means for a sub-menu within the challenge screen that will verify v.i.p. member 2 challenge, the video game to be played and the amount of challenge points that can be won after the video game competition is completed. once all of these criteria are set, both or all of equal numbers of video game players can therefore enter the video game platform and begin competing against each other in the video game environment, and rigidly connected to said means for a sub-menu within the challenge screen that will verify v.i.p. member 1 challenge, the video game to be played and the amount of challenge points that can be won after the video game competition is completed. once all of these criteria are set, both or all of equal numbers of video game players can therefore enter the video game platform and begin competing against each other in the video game environment;
means for the ultimate gamer challenge maker application verification application of the video game that was played and the outcome of said contest the ultimate gamer challenge maker application will verify that the video game competition was played according to the rules of said video game and then issue the winning challenge points to the winning virtual interactive professional (v.i.p.) the winning virtual interactive professional will also receive winner experience points these winner experience points will allow the v.i.p. to access one of four levels of gaming experience after achieving a pre-determined winner experience points number in order to level up these four levels will be labeled as rookie, professional, all-star and master, rigidly connected to said means for the video game competition that is being played in said agreed to competition; and
means for application reverting to the initial entry into the ultimate gamer challenge maker application after the video game players finish playing the said competition and finish circumventing the various sub-menu's, the gamer is once again directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment, rigidly connected to said means for the ultimate gamer challenge maker application verification application of the video game that was played and the outcome of said contest the ultimate gamer challenge maker application will verify that the video game competition was played according to the rules of said video game and then issue the winning challenge points to the winning virtual interactive professional (v.i.p.) the winning virtual interactive professional will also receive winner experience points these winner experience points will allow the v.i.p. to access one of four levels of gaming experience after achieving a pre-determined winner experience points number in order to level up. these four levels will be labeled as rookie, professional, ail-star and master.

2. The ultimate gamer challenge maker in accordance with claim 1, wherein said means for the initial entry into the ultimate gamer challenge maker application after the video game players enters into our system, the gamer is directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment comprises a virtual interactive professional main menu.

3. The ultimate gamer challenge maker in accordance with claim 1, wherein said means for wherein the gamer can explore how many players are available to compete against after the gamer selects another v.i.p. member from the challenge screen menu; the gamer can then set the video game that is to be played and set the amount of challenge points that the gamer wants to wager for the video game contest using the challenge point system comprises a challenge screen menu.

4. The ultimate gamer challenge maker in accordance with claim 1, wherein said means for a sub-menu within the challenge screen that will verify v.i.p. member 1 challenge, the video game to be played and the amount of challenge points that can be won after the video game competition is completed once all of these criteria are set, both or all of equal numbers of video game players can therefore enter the video game platform and begin competing against each other in the video game environment comprises a video game player 1 challenge screen sub-menu.

5. The ultimate gamer challenge maker in accordance with claim 1, wherein said means for a sub-menu within the challenge screen that will verify v.i.p. member 2 challenge, the video game to be played and the amount of challenge points that can be won after the video game competition is completed once all of these criteria are set, both or all of equal numbers of video game players can therefore enter the video game platform and begin competing against each other in the video game environment comprises a video game player 2 challenge screen sub-menu.

6. The ultimate gamer challenge maker in accordance with claim 1, wherein said means for the video game competition that is being played in said agreed to competition comprises a video game competition.

7. The ultimate gamer challenge maker in accordance with claim 1, wherein said means for the ultimate gamer challenge maker application verification application of the video game that was played and the outcome of said contest the ultimate gamer challenge maker application will verify that the video game competition was played according to the rules of said video game and then issue the winning challenge points to the winning virtual interactive professional (v.i.p.) the winning virtual interactive professional will also receive winner experience points. these winner experience points will allow the v.i.p. to access one of four levels of gaming experience after achieving a pre-determined winner experience points number in order to level up these four levels will be labeled as rookie, professional, all-star and master comprises the ultimate gamer challenge maker verification menu.

8. The ultimate gamer challenge maker in accordance with claim 1, wherein said means for application reverting to the initial entry into the ultimate gamer challenge maker application after the video game players finish playing the said competition and finish circumventing the various sub-menu's, the gamer is once again directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment comprises a virtual interactive professinal main menu.

9. An ultimate gamer challenge maker for facilitating video game players to live in a virtual world, become virtual professional video game players and compete against one another, comprising:
a virtual interactive professional main menu, for the initial entry into the ultimate gamer challenge maker application after the video game players enters into our system, the gamer is directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment;
a challenge screen menu, for wherein the gamer can explore how many players are available to compete against after the gamer selects another v.i.p. member from the challenge screen menu; the gamer can then set the video game that is to be played and set the amount of challenge points that the gamer wants to wager for the video game contest using the challenge point system, sealably connected to said Virtual Interactive Professional Main Menu;
a video game player 1 challenge screen sub-menu, for a sub-menu within the challenge screen that will verify v.i.p. member 1 challenge, the video game to be played and the amount of challenge points that can be won after the video game competition is completed once all of these criteria are set, both or all of equal numbers of video game players can therefore enter the video game platform and begin competing against each other in the video game environment, rigidly connected to said Challenge Screen Menu;
a video game player 2 challenge screen sub-menu, for a sub-menu within the challenge screen that will verify v.i.p. member 2 challenge, the video game to be played and the amount of challenge points that can be won after the video game competition is completed once all of these criteria are set, both or all of equal numbers of video game players can therefore enter the video game platform and begin competing against each other in the video game environment, rigidly connected to said Challenge Screen Menu;
a video game competition, for the video game competition that is being played in said agreed to competition, rigidly connected to said Video Game Player 2 Challenge Screen Sub-Menu, and rigidly connected to said Video Game Player 1 Challenge Screen Sub-Menu;
the ultimate gamer challenge maker verification menu, for the ultimate gamer challenge maker application verification application of the video game that was played and the outcome of said contest the ultimate gamer challenge maker application will verify that the video game competition was played according to the rules of said video game and then issue the winning challenge points to the winning virtual interactive professional (v.i.p.) the winning virtual interactive professional will also receive winner experience points. these winner experience points will allow the v.i.p. to access one of four levels of gaming experience after achieving a pre-determined winner experience points number in order to level up these four levels will be labeled as rookie, professional, all-star and master, rigidly connected to said Video Game Competition; and
a virtual interactive professinal main menu, for application reverting to the initial entry into the ultimate gamer challenge maker application after the video game players finish playing the said competition and finish circumventing the various sub-menu's, the gamer is once again directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment, rigidly connected to said The Ultimate Gamer Challenge Maker Verification Menu.

10. An ultimate gamer challenge maker for facilitating video game players to live in a virtual world, become virtual professional video game players and compete against one another, comprising:
a virtual interactive professional main menu, for the initial entry into the ultimate gamer challenge maker application after the video game players enters into our system, the gamer is directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment;
a challenge screen menu, for wherein the gamer can explore how many players are available to compete against after the gamer selects another v.i.p. member from the challenge screen menu; the gamer can then set the video game that is to be played and set the amount of challenge points that the gamer wants to wager for the video game contest using the challenge point system, sealably connected to said Virtual Interactive Professional Main Menu;
a video game player 1 challenge screen sub-menu, for a sub-menu within the challenge screen that will verify v.i.p. member 1 challenge, the video game to be played and the amount of challenge points that can be won after the video game competition is completed once all of these criteria are set, both or all of equal numbers of video game players can therefore enter the video game platform and begin competing against each other in the video game environment, rigidly connected to said Challenge Screen Menu;
a video game player 2 challenge screen sub-menu, for a sub-menu within the challenge screen that will verify v.i.p. member 2 challenge, the video game to be played and the amount of challenge points that can be won after the video game competition is completed once all of these criteria are set, both or all of equal numbers of video game players can therefore enter the video game platform and begin competing against each other in the video game environment, rigidly connected to said Challenge Screen Menu;
a video game competition, for the video game competition that is being played in said agreed to competition, rigidly connected to said Video Game Player 2 Challenge Screen Sub-Menu, and rigidly connected to said Video Game Player 1 Challenge Screen Sub-Menu;
the ultimate gamer challenge maker verification menu, for the ultimate gamer challenge maker application verification application of the video game that was played and the outcome of said contest the ultimate gamer challenge maker application will verify that the video game competition was played according to the rules of said video game and then issue the winning challenge points to the winning virtual interactive professional (v.i.p.) the winning virtual interactive professional will also receive winner experience points these winner experience points will allow the v.i.p. to access one of four levels of gaming experience after achieving a pre-determined winner experience points number in order to level up these four levels will be labeled as rookie, professional, all-star and master, rigidly connected to said Video Game Competition; and
a virtual interactive professinal main menu, for application reverting to the initial entry into the ultimate gamer challenge maker application after the video game players finish playing the said competition and finish circumventing the various sub-menu's, the gamer is once again directed into the video game player's virtual interactive professional (v.i.p.) page where the video game players has various options such as but not limited to buying virtual accessories, housing, exchanging winning challenge points for gift cards, challenging other members in our service or navigating the ultimate gamer challenge maker vast virtual environment, rigidly connected to said The Ultimate Gamer Challenge Maker Verification Menu.
